(19) United States
(12) Patent Application Publication
(10) Pub. No.: US 2024/0286923 A1
(43) Pub. Date: Aug. 29, 2024

(54) METHOD FOR PRODUCING LITHIUM METAL COMPOSITE OXIDE

(71) Applicant: SUMITOMO CHEMICAL COMPANY, LIMITED, Tokyo (JP)

(72) Inventor: Takahiro SHOJI, Niihama-shi (JP)

(73) Assignee: SUMITOMO CHEMICAL COMPANY, LIMITED, Tokyo (JP)

(21) Appl. No.: 18/572,773

(22) PCT Filed: Jun. 24, 2022
(86) PCT No.: PCT/JP2022/025264

§ 371 Date: Dec. 20, 2023

(30) Foreign Application Priority Data
Jun. 28, 2021 (JP) 2021-106557

(51) Int. Cl. C01G 53/00

(52) U.S. Cl. CPC C01G 53/50; C01P 2006/40

(57) ABSTRACT

A method for producing a lithium metal composite oxide, including a calcining step of introducing a gas mixture inside a calcining furnace and calcining a substance to be calcined in the calcining furnace at a temperature of higher than 600° C., in which the substance to be calcined is a raw material mixture containing a mixture of a metal composite compound and a lithium compound or a reaction product of the metal composite compound and the lithium compound, the gas mixture before introduction contains oxygen, an amount of moisture in the gas mixture is 8 vol % or more and 85 vol % or less, and an amount of carbon dioxide in the gas mixture is less than 4 vol %.

### CROSS-REFERENCE TO RELATED APPLICATIONS

The present application claims priority under 35 U.S.C. § 371 to International Patent Application No. PCT/JP2022/025264, filed Jun. 24, 2022, which claims priority to and the benefit of Japanese Patent Application No. 2021-106557, filed Jun. 28, 2021. The contents of these applications are hereby incorporated by reference in their entireties.

### TECHNICAL FIELD

The present invention relates to a method for producing a lithium metal composite oxide.

### BACKGROUND ART

For positive electrode active materials used in the positive electrodes of lithium secondary batteries, lithium metal composite oxides are used. Methods for producing lithium metal composite oxides include, for example, a calcining step of calcining a substance to be calcined, such as a mixture of a metal composite compound and a lithium compound, or a reaction product of a metal composite compound and a lithium compound.

For the purpose of controlling physical properties of lithium metal composite oxides, calcining conditions such as calcining temperature and calcining atmosphere have been investigated. For example, Patent Document 1 discloses a method for producing a positive electrode active material for a lithium secondary battery with the aim of improving cycle characteristics. Patent Document 1 discloses a method in which a heat treatment is carried out on a mixture of nickel oxyhydroxide and lithium hydroxide at a temperature of 100° C. or higher and 500° C. or lower and in the presence of water vapor.

### CITATION LIST

### Patent Literature

Patent Literature 1: JP-A-2001-102054

### SUMMARY OF INVENTION

### Technical Problem

By improving crystallinity of lithium metal composite oxides, it can be expected to improve the cycle characteristics of lithium secondary batteries. For improvement in the crystallinity of the lithium metal composite oxides, there is room for investigation on calcining conditions.

The present invention has been made in view of the above-described circumstances, and an object of the present invention is to provide a method for producing a lithium metal composite oxide capable of obtaining a lithium secondary battery with a high cycle retention rate.

### Solution to Problem

The present invention includes [1] to [6].
[1] A method for producing a lithium metal composite oxide, including a calcining step of introducing a gas mixture inside a calcining furnace and calcining a substance to be calcined in the calcining furnace at a temperature of higher than 600° C., in which the substance to be calcined is a raw material mixture containing a mixture of a metal composite compound and a lithium compound or a reaction product of the metal composite compound and the lithium compound, the gas mixture before introduction contains oxygen, an amount of moisture in the gas mixture is 8 vol % or more and 85 vol % or less, and an amount of carbon oxide in the gas mixture is less than 4 vol %.
[2] The method for producing the lithium metal composite oxide according to [1], in which an amount of oxygen in the gas mixture before introduction is 10 vol % or more and 92 vol % or less.
[3] The method for producing the lithium metal composite oxide according to [1] or [2], in which a total amount of moisture (m³) introduced into the calcining furnace with respect to a charged powder mass (kg) of the substance to be calcined is 0.1 m³/kg or more and 20 m³/kg or less.
[4] The method for producing the lithium metal composite oxide according to any one of [1] to [3], in which a calcining time in the calcining step is 1 hour or longer and 24 hours or shorter.
[5] The method for producing the lithium metal composite oxide according to any one of [1] to [4], including a cooling step of cooling a calcined product inside the calcining furnace after the calcining step, in which a gas with a dew point of −15° C. or lower is supplied inside the calcining furnace in the cooling step.
[6] The method for producing the lithium metal composite oxide according to any one of [1] to [5], in which the lithium metal composite oxide satisfies General Formula (I) below.

Li[Liₓ(Ni_{(1-y-z)}Co_{y}X_{z})₁₋ₓ]O₂ (I)

(In Formula (I), wherein X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y≤0.4, and 0≤z≤0.5 are satisfied.)

### Advantageous Effect of Invention

According to the present invention, it is possible to provide a method for producing a lithium metal composite oxide capable of obtaining a lithium secondary battery with a high cycle retention rate.

### BRIEF DESCRIPTION OF DRAWINGS

FIG. 1 is a schematic view showing an example of a lithium secondary battery.

FIG. 2 is a schematic view showing an example of an all-solid-state lithium secondary battery.

FIG. 3 is a schematic view showing an example of a calcining means.

### DESCRIPTION OF EMBODIMENTS

In the present specification, a metal composite compound will be hereinafter referred to as “MCC”.

A lithium metal composite oxide will be hereinafter referred to as “LiMO”.

A positive electrode active material for a lithium secondary battery will be hereinafter referred to as “CAM” as an abbreviation for a cathode active material for a lithium secondary battery.

“Ni” refers not to a nickel metal but to a nickel atom. “Co”, “Li”, and the like also, similarly, each refer to a cobalt atom, a lithium atom, or the like.

For numerical ranges, for example, in a case where a numerical range is expressed as, “1 to 10 μm”, this means a numerical range from 1 μm to 10 μm including the lower limit value (1 μm) and the upper limit value (10 μm), that is “1 μm or more and 10 μm or less”.

In the present specification, the cycle retention rate of the lithium secondary battery is measured by the following method.

### <Measurement of Cycle Retention Rate>

### (Production of Positive Electrode for Lithium Secondary Battery)

Using LiMO produced by the production method of the present embodiment, a paste-like positive electrode mixture is prepared by adding and kneading LiMO, a conductive material, and a binder at a proportion that brings about a composition of LiMO:conductive material:binder=92:5:3 (mass ratio). During the preparation of the positive electrode mixture, N-methyl-2-pyrrolidone is used as an organic solvent. Acetylene black is used as the conductive material. Polyvinylidene fluoride is used as the binder.

The obtained positive electrode mixture is applied to an Al foil having a thickness of 40 μm, which is to serve as a current collector, and dried in a vacuum at 150° C. for 8 hours, thereby obtaining a positive electrode for a lithium secondary battery. The positive electrode area of the positive electrode for the lithium secondary battery is set to 1.65 cm².

### (Production of Lithium Secondary Battery)

The following operation is performed in a glove box under an argon atmosphere.

The positive electrode for the lithium secondary battery produced in the section (Production of positive electrode for lithium secondary battery) is placed on the lower lid of a part for a coin-type battery R2032 (manufactured by Hohsen Corp.) with the aluminum foil surface facing downward, and a separator (a polyethylene porous film) is placed on the positive electrode. An electrolytic solution (300 μl) is poured thereinto. The electrolytic solution used is one obtained by dissolving LiPF₆ in a liquid mixture of ethylene carbonate, dimethyl carbonate, and ethyl methyl carbonate in 30:35:35 (volume ratio) so as to reach a proportion of 1.0 mol/l.

Next, lithium metal is used as a negative electrode, and the negative electrode is placed on the upper side of the separator. An upper lid is placed through a gasket and caulked using a caulking machine, thereby producing a lithium secondary battery (coin-type half cell R2032).

### (Cycle Retention Rate)

Using a lithium secondary battery produced by the above method, the cycle retention rate is measured by the following method. A cycle retention rate of 90% or more, as measured by the following method, is evaluated as “high cycle retention rate”.

After producing the lithium secondary battery, it is allowed to stand for 12 hours at room temperature to fully impregnate the separator and the positive electrode mixture layer with the electrolytic solution.

At a test temperature of 25° C., constant current constant voltage charging and constant current discharging are carried out with a current set value of 0.2 CA for both charging and discharging, respectively. The maximum charging voltage is set to 4.3 V and the minimum discharging voltage is set to 2.5 V.

Next, at 25° C., with the current set value for both charging and discharging set to 1 CA, 50 cycles of a charging and discharging test were carried out in which constant current constant voltage charging with constant current charging to 4.3 V and then constant voltage charging at 4.3 V was carried out, followed by constant current discharging to 2.5 V, and the discharge capacity (mAh/g) of each charging and discharging cycle is measured.

The cycle retention rate is calculated according to the following expression from the discharge capacity at the 1^{st} cycle and the discharge capacity at the 50^{th} cycle obtained in the above-described charging and discharging test. A higher cycle retention rate means that the decrease in battery capacity after repeated charging and discharging is suppressed, which is thus desirable for battery performance.

$$Cycle retention rate ( \% ) = Discharge capacity at {50}^{th} cycle ( mAh / g ) / Discharge capacity at {1}^{st} cycle ( mAh / g ) \times 100$$

### <Method for Producing Lithium Metal Composite Oxide>

A method for producing LiMO of the present embodiment includes a calcining step of calcining a substance to be calcined in a calcining furnace as an essential step. It is preferable that the method for producing LiMO includes a step of obtaining MCC and a step of obtaining a mixture. The step of obtaining MCC, the step of obtaining a mixture, and the calcining step will be described below, in this order.

### <<Step of Obtaining MCC>>

MCC may be any of a metal composite hydroxide, a metal composite oxide, and a mixture of these. The metal composite hydroxide and metal composite oxide, as an example, contain Ni, Co, and an element X at a molar ratio represented by the following formula (A).

$$Ni : Co : X = ( 1 - y - z ) : y : z \qquad ( A )$$

(In the formula (A), the element X represents one or more elements selected from the group consisting of Mn, Fe, Cu, Ti, Mg, Al, W, Mo, Nb, Zn, Sn, Zr, Ga, B, Si, S, and P, and 0≤y≤0.4 and 0≤z≤0.5 are satisfied.)

Hereinafter, the production method is described in detail, using as an example MCC containing Ni, Co, and Mn as metal elements. First, a metal composite hydroxide containing Ni, Co, and Mn is prepared.

Usually, the metal composite hydroxide can be produced by the well-known batch co-precipitation method or continuous co-precipitation method.

First, a nickel salt solution, a cobalt salt solution, a manganese salt solution, and a complexing agent are reacted by the co-precipitation method, in particular, the continuous method disclosed in JP-A-2002-201028, thereby producing a metal composite hydroxide represented by Ni_{(1-y-z)}Co_{y}Mn_{z}(OH)₂ (in the formula, y+z<1).

A nickel salt that is a solute of the nickel salt solution is not particularly limited, and, for example, at least one of nickel sulfate, nickel nitrate, nickel chloride, and nickel acetate can be used.

As a cobalt salt that is a solute of the cobalt salt solution, for example, at least one of cobalt sulfate, cobalt nitrate, cobalt chloride, and cobalt acetate can be used. As a manganese salt that is a solute of the manganese salt solution, for example, at least one of manganese sulfate, manganese nitrate, and manganese chloride can be used.

The above-described metal salts are used in ratios corresponding to the composition ratio of Ni_{(1-y-z)}Co_{y}Mn_{z}(OH)₂. In addition, as the solvent, water is used.

The complexing agent is a compound capable of forming a complex with a nickel ion, a cobalt ion, and a manganese ion in an aqueous solution. Examples of the complexing agent include an ammonium ion donor, hydrazine, ethylenediaminetetraacetic acid, nitrilotriacetic acid, uracildiacetic acid, and glycine.

Examples of the ammonium ion donor include ammonium salts such as ammonium hydroxide, ammonium sulfate, ammonium chloride, ammonium carbonate, and ammonium fluoride.

In a case where the complexing agent is contained, regarding the amount of the complexing agent that is contained in the liquid mixture containing the nickel salt solution, the cobalt salt solution, the manganese salt solution, and the complexing agent, for example, the molar ratio of the complexing agent to the sum of the mole numbers of the metal salts is more than 0 and 2.0 or less.

In the co-precipitation method, in order to adjust the pH value of the liquid mixture containing the nickel salt solution, the cobalt salt solution, the manganese salt solution, and the complexing agent, an alkaline aqueous solution is added to the liquid mixture before the pH of the liquid mixture turns from alkaline into neutral. The alkaline aqueous solution used can be sodium hydroxide or potassium hydroxide.

The value of the pH in the present specification is defined as a value measured when the temperature of the liquid mixture is 40° C. The pH of the liquid mixture is measured when the temperature of the liquid mixture sampled from a reaction vessel reaches 40° C.

In a case where the temperature of the sampled liquid mixture is lower than 40° C., the liquid mixture is heated and the pH is measured when the temperature reaches 40° C.

In a case where the temperature of the sampled liquid mixture is higher than 40° C., the liquid mixture is cooled and the pH is measured when the temperature reaches 40° C.

When the complexing agent in addition to the nickel salt solution, the cobalt salt solution, and the manganese salt solution is continuously supplied to the reaction vessel, Ni, Co, and Mn react with one another, and Ni_{(1-y-z)}Co_{y}Mn_{z}(OH)₂ is generated.

At the time of the reaction, the temperature of the reaction vessel is controlled within the range of, for example, 20 to 80° C., preferably 30 to 70° C.

In addition, at the time of the reaction, the pH value in the reaction vessel is controlled within the range of, for example, pH 9 to pH 13, preferably pH 11 to pH 13.

The substances in the reaction vessel are stirred and mixed together as appropriate.

As the reaction vessel that is used in the continuous co-precipitation method, it is possible to use a reaction vessel in which the formed reaction precipitate is caused to overflow for separation.

In addition to the control of the above conditions, a variety of gases, for example, an inert gas such as nitrogen, argon, or carbon dioxide, an oxidizing gas such as an air or oxygen, or a gas mixture thereof may be supplied into the reaction vessel.

After the above reaction, the obtained reaction precipitate is washed with water and dehydrated, and then dried to obtain a metal composite hydroxide containing Ni, Co, and Mn. If necessary, the reaction precipitate may also be washed with a weak acid water or an alkaline solution containing sodium hydroxide or potassium hydroxide.

In the above example, the metal composite hydroxide containing Ni, Co, and Mn is produced as MCC, but a metal composite oxide containing Ni, Co, and Mn may be prepared.

For example, a metal composite oxide containing Ni, Co, and Mn can be prepared by heating the metal composite hydroxide containing Ni, Co, and Mn at 400 to 700° C.

### <<Step of Obtaining Mixture>>

MCC obtained by the above-described method is mixed with a lithium compound to obtain a mixture of MCC and the lithium compound.

As the lithium compound, one or more selected from the group consisting of lithium carbonate, lithium hydroxide, and lithium hydroxide monohydrate can be used.

The lithium compound and MCC are mixed in consideration of the composition ratio of a final target product to obtain a mixture. Specifically, it is preferable that the lithium compound and MCC are mixed at ratios corresponding to the composition ratio of General Formula (I) to be described below.

The mixture of MCC and the lithium compound may be heated before the calcining step to be described below. By heating the mixture, a raw material mixture containing a reaction product of MCC and the lithium compound can be obtained. That is, the raw material mixture may contain a reaction product in which some of MCC and the lithium compound contained in the above mixture have reacted, and may further contain MCC and the lithium compound.

The heating temperature at which the mixture is heated is, for example, 300 to 700° C.

The raw material mixture containing a mixture of MCC and the lithium compound or a reaction product of MCC and the lithium compound can be adopted as the substance to be calcined in the calcining step to be described below.

### <<Calcining Step>>

The substance to be calcined is calcined using a calcining furnace.

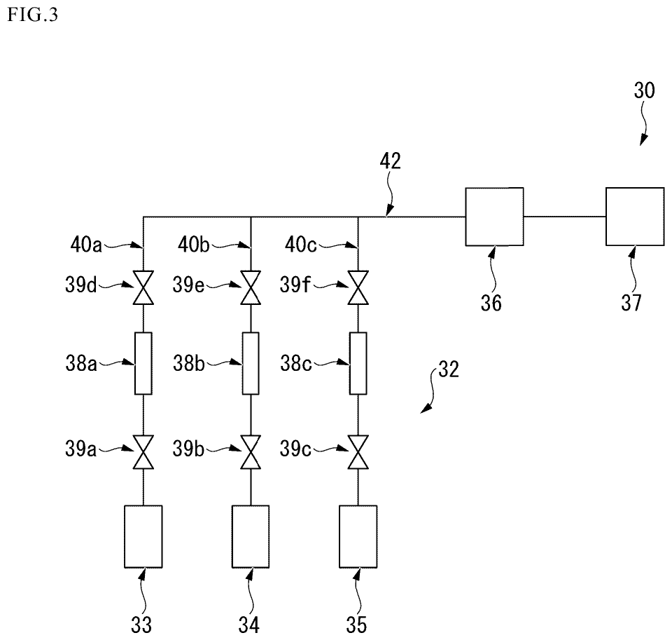

The calcining means that is suitably used for the present embodiment is described using FIG. 3. FIG. 3 shows a calcining means 30 that can be suitably used for the present embodiment. The calcining means 30 is equipped with a gas supply device 32, a moisture supply means 36, and a calcining furnace 37.

The gas supply device 32 is equipped with an oxygen gas supply means 33, an inert gas supply means 34, and an optional carbon dioxide gas supply means 35. The inert gas supply means 34 is a means of supplying an inert gas other than carbon dioxide gas (for example, nitrogen or argon). The gas supply device 32 may or may not be equipped with the carbon dioxide gas supply means 35.

The supply means are each connected to the respective supply channels 40a, 40b, and 40c. Valves 39a, 39b, 39c, 39d, 39e and 39f may be provided upstream and downstream of each of the supply channels 40a, 40b and 40c, respectively, for selecting gas distribution and shut-off, respectively.

Each of the supply channels 40a, 40b, and 40c may be equipped with flow meters 38a, 38b, and 38c, respectively.

Each of the supply channels 40a, 40b, and 40c is combined into a single supply channel 42 on the downstream side, and the supply channel 42 is connected to the moisture supply means 36.

The gas supplied to the moisture supply means 36 is, for example, an oxygen gas or a gas containing an oxygen gas and an inert gas. For the sake of convenience, the gas supplied to the moisture supply means 36 is referred to as “raw material gas”.

For example, when the valves 39b, 39c, 39e, and 39f are closed and the valves 39a and 39d are opened, an oxygen gas is supplied to the moisture supply means 36 as a raw material gas.

Alternatively, when the valves 39c and 39f are closed and the valves 39a, 39d, 39b, and 39e are opened, gases containing an oxygen gas and an inert gas are supplied to the moisture supply means 36 as a raw material gas.

The moisture supply means 36 is connected to the calcining furnace 37. The calcining furnace 37 is a calcining furnace for accommodating and calcining the substance to be calcined. The connection section between the moisture supply means 36 and the calcining furnace 37 may be heated to around 100° C., for example, in order to prevent condensation due to the moisture in the gas mixture.

The moisture supply means 36 supplies moisture to the raw material gas supplied from the supply channel 42. As examples of the moisture supply means 36, each of the moisture supply mean s of Example A to Example C below is an exemplary example.

### Example A

A moisture supply means of Example A supplies moisture to the raw material gas by bubbling. The moisture supply means of Example A is equipped with a water tank equipped with water and a heating means of heating the water in the water tank.

Specifically, first, the water temperature is adjusted to 41 to 96° C. by heating the water in the water tank with the heating means. Next, the raw material gas is bubbled through the water after the water temperature has been adjusted. This provides a gas mixture in which moisture has been supplied to the raw material gas. When the above-described water temperature is increased, the amount of moisture in the gas mixture (hereinafter, referred to as “moisture concentration” in some cases) can be increased, and when the above-described water temperature is decreased, the moisture concentration in the gas mixture can be decreased.

### [Moisture Concentration]

The moisture concentration [vol %] of a gas at the atmospheric pressure (101325 Pa) is expressed by the following expression (X), using the water vapor pressure p (Pa).

$$Moisture concentration [ vol \% ] = ( p [ Pa ] / 101325 [ Pa ] ) \times 100 \qquad Expression ( X )$$

The relationship between the saturated water vapor pressure and temperature (that is, dew point) of a one component liquid is expressed by the following expression (Y), which is described in the AIChE Design Institute for Physical Properties (DIPPR). Here, p is the water vapor pressure (Pa) and t is the dew point (K).

$$p = EXP ( 73.649 - 7258.2 / t - 7.3037 \times ln ( t ) + 0.0000041653 \times {t}^{2} ) \qquad Expression ( Y )$$

Using the above expression (X), the water vapor pressure p at which the moisture concentration in the gas mixture becomes the target value is calculated, and by substituting it into the above expression (Y), the dew point t at which the gas mixture having the target moisture concentration can be obtained is calculated.

Then, the water temperature in the water tank is controlled so as to achieve the calculated dew point t, and the raw material gas is bubbled through the water with the controlled water temperature, thereby obtaining a gas mixture that satisfies the target moisture concentration.

### Example B

A moisture supply means of Example B is equipped with a bubble tower. By filling the bubble tower with water held at a predetermined temperature and supplying the raw material gas to the bubble tower, a gas mixture in which moisture has been supplied to the raw material gas is obtained. The moisture concentration of the gas mixture can be adjusted by adjusting the temperature of the water that fills the bubble tower.

### Example C

A moisture supply means of Example C is equipped with a spraying device. By spraying misty water to the raw material gas with the spraying device, a gas mixture in which moisture has been supplied to the raw material gas can be obtained. In a case where the moisture supply means of Example C is used, the moisture concentration of the gas mixture can be adjusted by increasing or decreasing the amount of water sprayed.

The gas mixture is supplied to the calcining furnace 37.

The gas mixture has a moisture concentration of 8 to 85 vol % in the total volume of the gas mixture in the composition before introduction into the calcining furnace 37, preferably 10 to 60 vol %, and still more preferably 20 to 40 vol %.

It is considered that, by supplying the gas mixture whose moisture concentration has been adjusted to the above-described range to the inside of the calcining furnace 37 and calcining the substance to be calcined, the crystallinity of the resulting LiMO is improved. A lithium secondary battery using such LiMO as CAM is likely to have an improved cycle retention rate. Here, “improved crystallinity” means a higher degree of crystallinity.

In the composition before introduction into the calcining furnace 37, the amount of carbon dioxide in the total volume of the gas mixture is less than 4 vol %, preferably 2 vol % or less, and more preferably 0 vol %.

By supplying the gas mixture in which the amount of carbon dioxide has been adjusted to the above-described range to the inside of the calcining furnace 37 and calcining the substance to be calcined, LiMO with a small amount of lithium carbonate remaining can be obtained. When such LiMO is used as CAM, carbon dioxide gas is unlikely to be generated when the lithium secondary battery is operated, and a lithium secondary battery with a high cycle retention rate can be obtained.

In the composition before introduction into the calcining furnace 37, the amount of oxygen in the total volume of the gas mixture is preferably 10 to 92 vol %, and more preferably more than 11 vol % and 92 vol % or less.

By supplying the gas mixture in which the amount of oxygen has been adjusted to the above-described range to the inside of the calcining furnace 37 and calcining the substance to be calcined, the reaction is accelerated and LiMO is easily obtained. A lithium secondary battery using such LiMO as CAM is likely to have an improved cycle retention rate.

The respective amounts of oxygen and carbon dioxide and the moisture concentration in the gas mixture are the values when the total volume of the gas mixture is defined as 100 vol %.

The respective amounts of oxygen and carbon dioxide and the moisture concentration in the gas mixture can be controlled by adjusting the flow rate of each gas supplied from the oxygen gas supply means 33, the inert gas supply means 34, and the carbon dioxide gas supply means 35, as well as the temperature of the water in the moisture supply means, for example.

The adjustment of flow rate of each gas can be performed by using a float flow meter equipped with a valve or the like when supplying each gas from the respective supply means.

In the composition before introduction into the calcining furnace 37, the gas mixture is preferably a gas mixture of the following (Example 1), (Example 2), or (Example 3).

(Example 1) A gas mixture with a moisture concentration of 8 vol % to 85 vol %, a carbon dioxide amount of less than 4 vol %, and an inert gas amount of more than 11 vol % and 92 vol % or less.

(Example 2) A gas mixture with a moisture concentration of 8 to 85 vol %, an oxygen amount of more than 11 vol % and 92 vol % or less, and a carbon dioxide amount of less than 4 vol %.

(Example 3) A gas mixture with a moisture concentration of 8 to 85 vol %, an oxygen amount of 10 to 92 vol %, an inert gas content of 1 to 30 vol %, and a carbon dioxide amount of less than 4 vol %.

In any of the above gas mixtures of (Example 1) to (Example 3), the amount of carbon dioxide is preferably 0 vol %.

The total amount of moisture (m³) introduced into the calcining furnace with respect to the charged powder mass (kg) of the substance to be calcined is preferably 0.1 to 20 m³/kg. The total amount of moisture (m³) introduced into the calcining furnace with respect to the charged powder mass (kg) of the substance to be calcined is referred to as “ratio of moisture to powder (m³/kg)”.

The above-described “charged powder mass of the substance to be calcined” is the mass of the substance to be calcined before calcining, which is to be injected into the calcining furnace.

The above-described “total amount of moisture introduced into the calcining furnace” is the total amount of moisture introduced into the calcining furnace 37 by the gas mixture. The ratio of moisture to powder (m³/kg) can be controlled by adjusting the flow rate of each gas supplied from each gas supply means and the temperature of the water in the moisture supply means.

The ratio of moisture to powder is more preferably 0.1 to 18 m³/kg, and still more preferably 0.3 to 15 m³/kg.

By controlling the ratio of moisture to powder in the above-described range and calcining the substance to be calcined, crystal growth is accelerated and LiMO with high crystallinity is easily obtained. A lithium secondary battery using such LiMO as CAM is likely to have an improved cycle retention rate.

The calcining temperature in the calcining furnace 37 is a temperature of higher than 600° C., preferably 700° C. or higher, and more preferably 800° C. or higher. The upper limit value of the calcining temperature is, for example, 1300° C. or lower, 1200° C. or lower, or 1100° C. or lower. In a case where a plurality of calcining steps is performed at different calcining temperatures, it is preferable that the calcining temperature of a calcining step performed at the highest temperature is in the above-described range.

The range of calcining temperature is, for example, higher than 600° C. and 1300° C. or lower, 700 to 1200° C., 700 to 1100° C., or the like.

By calcining the substance to be calcined at a temperature of higher than 600° C., crystal growth is accelerated and LiMO with high crystallinity is easily obtained. A lithium secondary battery using such LiMO as CAM is likely to have an improved cycle retention rate.

In the present embodiment, in a case where a plurality of calcining steps is performed at different calcining temperatures, it is preferable that all of the calcining steps are performed at a temperature of higher than 600° C.

The calcining temperature means the highest holding temperatures of the atmosphere in the calcining furnace.

The time for holding at the calcining temperature is referred to as calcining time. The calcining time is preferably 1 to 24 hours and more preferably 3 to 12 hours.

The total time from the initiation of temperature rise until the temperature is reached and temperature holding is terminated is preferably 1 to 30 hours. The temperature rising rate in the calcining step is preferably 15° C./hour or faster, more preferably 30° C./hour or faster, and particularly preferably 45° C./hour or faster.

In the present specification, the temperature rising rate is calculated from the time taken while the temperature begins to be raised and then reaches the highest temperature in the calcining device, and the temperature difference between the temperature at the initiation of the temperature rise and the highest temperature in the calcining furnace of the calcining device.

The calcined product obtained by the calcining step is washed and pulverized as appropriate to obtain LiMO.

### Cooling Step

A cooling step is preferably provided after the calcining step. The cooling step is a step of cooling the calcined product inside the calcining furnace. In the cooling step, it is preferable to supply a gas with a dew point of −15° C. or lower inside the calcining furnace. Hereinafter, a gas with a dew point of −15° C. or lower is referred to as “low dew point gas” in some cases. It is also preferable that the cooling step cools the calcined product to room temperature. Examples of the low dew point gas include an oxygen-containing gas or inert-containing gas with a dew point of −15° C. or lower.

In the cooling step, the timing for supplying the low dew point gas is, for example, immediately after the calcining is completed for the calcining time described above.

For example, the low dew point gas can be supplied to the calcining furnace immediately after the calcining is completed for the calcining time described above by connecting a means of supplying the low dew point gas to the calcining furnace 37 in advance via a supply channel and a valve, and immediately after the calcining is completed, stopping the supply of the gas mixture from the moisture supply means and opening the valve on the side of the means of supplying the low dew point gas.

By supplying the low dew point gas to the inside of the calcining furnace and cooling the calcined product, LiMO is obtained. LiMO produced through the cooling step has a low amount of moisture. A lithium secondary battery using such LiMO as CAM is likely to have an improved cycle retention rate.

### <Lithium Metal Composite Oxide>

### <<Composition>>

It is preferable that LiMO produced by the production method of the present embodiment satisfies General Formula (I) below.

Li[Liₓ(Ni_{(1-y-z)}Co_{y}X_{z})₁₋ₓ]O₂ (I)

(In Formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y≤0.4, and 0≤z≤0.5 are satisfied.)

(x)

From the viewpoint of obtaining a lithium secondary battery with a high cycle retention rate, x is preferably-0.02 or more, more preferably more than 0, still more preferably 0.01 or more, and even still more preferably 0.02 or more. In addition, from the viewpoint of obtaining a lithium secondary battery with a higher initial coulombic efficiency, x is preferably 0.1 or less, more preferably 0.08 or less, and still more preferably 0.06 or less.

The upper limit value and lower limit value of x can be randomly combined together.

As the combination for x, −0.02 to 0.1, more than 0 and 0.1 or less, 0.01 to 0.08, and 0.02 to 0.06 are exemplary examples.

(y)

From the viewpoint of obtaining a lithium secondary battery with a low battery internal resistance, y is preferably more than 0, more preferably 0.005 or more, still more preferably 0.01 or more, even more preferably 0.03 or more, and even still more preferably 0.05 or more. In addition, in view of obtaining a lithium secondary battery with high thermal stability, y is preferably 0.4 or less, more preferably 0.35 or less, and still more preferably 0.33 or less.

The upper limit value and lower limit value of y can be randomly combined together.

As the combination for y, more than 0 and 0.4 or less, 0.005 to 0.4, 0.01 to 0.35, 0.03 to 0.33, and 0.05 to 0.33 are exemplary examples.

(z)

From the viewpoint of obtaining a lithium secondary battery with a high cycle retention rate, z is preferably 0.01 or more, more preferably 0.02 or more, and still more preferably 0.03 or more. In addition, from the viewpoint of obtaining a lithium secondary battery with high storage characteristics at a high temperature (for example, under 60° C. environment), z is preferably 0.49 or less, and more preferably 0.48 or less.

The upper limit value and lower limit value of z can be randomly combined together.

As the combination for z, 0.01 to 0.5, 0.02 to 0.49, and 0.03 to 0.48 are exemplary examples.

(y+z)

From the viewpoint of obtaining a lithium secondary battery with a high cycle retention rate, y+z is preferably more than 0, more preferably more than 0 and 0.8 or less, and still more preferably more than 0 and 0.78 or less.

X represents one or more elements selected from the group consisting of Mn, Fe, Cu, Ti, Mg, Al, W, Mo, Nb, Zn, Sn, Zr, Ga, B, Si, S, and P.

In addition, X is preferably one or more elements selected from the group consisting of Mn, Ti, Mg, Al, W, B, Zr, and Nb from the viewpoint of obtaining a lithium secondary battery with a high cycle retention rate, and preferably one or more elements selected from the group consisting of Mn, Al, W, B, Zr, and Nb from the viewpoint of obtaining a lithium secondary battery with high thermal stability.

Examples of General Formula (I) described above include General Formula (I′) below.

Li[Liₓ(Ni_{(1-y-z)}CO_{y}X_{z})₁₋ₓ]O₂ (I′)

(In the Formula (I), X represents one or more elements selected from the group consisting of Mn, Al, W, B, Zr, and Nb, and −0.03≤x≤0.1, 0.01≤y≤0.35, and 0.03≤z≤0.48 are satisfied.)

### <Composition Analysis>

The composition of LiMO can be analyzed by dissolving the obtained LiMO powder in hydrochloric acid and then performing measurement using an ICP emission spectrometer.

The ICP emission spectrometer used can be SPS3000 manufactured by Seiko Instruments Inc., for example.

### <Positive Electrode Active Material for Lithium Secondary Battery>

LiMO produced by the production method of the present embodiment can be suitably used as CAM.

CAM of the present embodiment contains LiMO. CAM may contain LiMO other than the present invention as long as the effects of the present invention are not impaired.

### <Lithium Secondary Battery>

The configuration of a lithium secondary battery that is suitable in a case where LiMO produced by the production method of the present embodiment is used as CAM will be described.

Furthermore, a positive electrode for a lithium secondary battery that is suitable in a case where LiMO produced by the production method of the present embodiment is used as CAM will be described. The positive electrode for a lithium secondary battery will be hereinafter referred to as positive electrode in some cases.

Furthermore, a lithium secondary battery that is suitable for an application of a positive electrode will be described.

An example of the lithium secondary battery that is suitable in a case where LiMO produced by the production method of the present embodiment is used as CAM has a positive electrode, a negative electrode, a separator interposed between the positive electrode and the negative electrode, and an electrolytic solution disposed between the positive electrode and the negative electrode.

An example of the lithium secondary battery has a positive electrode, a negative electrode, a separator interposed between the positive electrode and the negative electrode, and an electrolytic solution disposed between the positive electrode and the negative electrode.

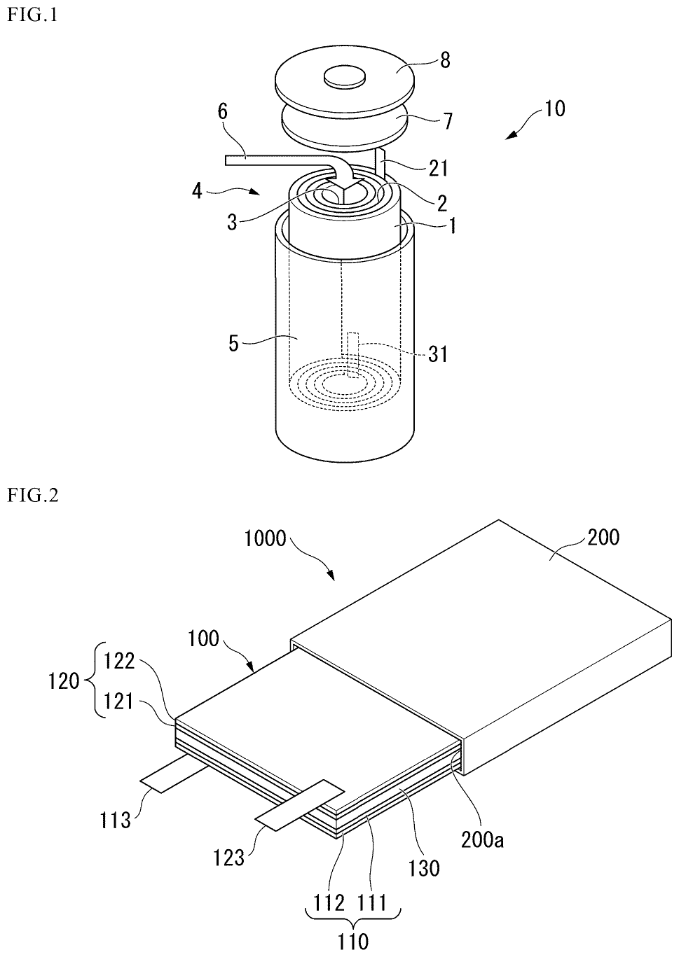

FIG. 1 is a schematic view showing an example of a lithium secondary battery. For example, a cylindrical lithium secondary battery 10 is produced as described below.

First, as shown in FIG. 1, a pair of separators 1 having a strip shape, a strip-shaped positive electrode 2 having a positive electrode lead 21 at one end, and a strip-shaped negative electrode 3 having a negative electrode lead 31 at one end are laminated in the order of the separator 1, the positive electrode 2, the separator 1, and the negative electrode 3 and are wound to form an electrode group 4.

Next, the electrode group 4 and an insulator, not shown, are accommodated in a battery can 5, and the can bottom is then sealed. The electrode group 4 is impregnated with an electrolytic solution 6, and an electrolyte is disposed between the positive electrode 2 and the negative electrode 3. Furthermore, the upper portion of the battery can 5 is sealed with a top insulator 7 and a sealing body 8, whereby the lithium secondary battery 10 can be produced.

As the shape of the electrode group 4, for example, a columnar shape in which the cross-sectional shape becomes a circle, an ellipse, a rectangle, or a rectangle with rounded corners when the electrode group 4 is cut in a direction perpendicular to the winding axis can be an exemplary example.

In addition, as a shape of the lithium secondary battery having the electrode group 4, a shape specified by IEC60086, which is a standard for a battery specified by the International Electrotechnical Commission (IEC), or by JIS C 8500 can be adopted. For example, shapes such as a cylindrical type and a square type can be exemplary examples.

Furthermore, the lithium secondary battery is not limited to the winding-type configuration and may have a laminate-type configuration in which the laminated structure of the positive electrode, the separator, the negative electrode, and the separator is repeatedly overlaid. As the laminate-type lithium secondary battery, a so-called coin-type battery, button-type battery, or paper-type (or sheet-type) battery can be an exemplary example.

Hereinafter, each configuration will be described in order.

### (Positive Electrode)

The positive electrode can be produced by, first, preparing a positive electrode mixture containing CAM, a conductive material, and a binder and supporting the positive electrode mixture by a positive electrode current collector.

### (Negative Electrode)

For the positive electrode, separator, negative electrode, and electrolytic solution that configure the lithium secondary battery, the configuration, materials, and production method disclosed in to of WO2022/113904A1, for example, can be used.

### <All-Solid-State Lithium Secondary Battery>

Next, a positive electrode for which LiMO produced by the production method of the present embodiment is used as CAM of an all-solid-state lithium secondary battery and an all-solid-state lithium secondary battery having this positive electrode will be described while describing the configuration of an all-solid-state lithium secondary battery.

FIG. 2 is a schematic view showing an example of an all-solid-state lithium secondary battery. An all-solid-state lithium secondary battery 1000 shown in FIG. 2 has a laminate 100 having a positive electrode 110, a negative electrode 120, and a solid electrolyte layer 130 and an exterior body 200 accommodating the laminate 100. In addition, the all-solid-state lithium secondary battery 1000 may have a bipolar structure in which CAM and a negative electrode active material are disposed on both sides of a current collector. As specific examples of the bipolar structure, for example, the structures disclosed in JP-A-2004-95400 are exemplary examples. A material that configures each member will be described below.

The laminate 100 may have an external terminal 113 that is connected to a positive electrode current collector 112 and an external terminal 123 that is connected to a negative electrode current collector 122. In addition, the all-solid-state lithium secondary battery 1000 may have a separator between the positive electrode 110 and the negative electrode 120.

The all-solid-state lithium secondary battery 1000 further has an insulator, not shown, that insulates the laminate 100 and the exterior body 200 from each other and a sealant, not shown, that seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been performed into a bag shape can also be used.

As the shape of the all-solid-state lithium secondary battery 1000, for example, shapes such as a coin type, a button type, a paper type (or a sheet type), a cylindrical type, a square type, and a laminate type (pouch type) can be exemplary examples.

As an example of the all-solid-state lithium secondary battery 1000, a form in which one laminate 100 is provided is shown in the drawings, but the present embodiment is not limited thereto. The all-solid-state lithium secondary battery 1000 may have a configuration in which the laminate 100 is used as a unit cell and a plurality of unit cells (laminates 100) is sealed inside the exterior body 200.

### (Positive Electrode)

The positive electrode 110 has a positive electrode active material layer 111 and a positive electrode current collector 112.

The positive electrode active material layer 111 contains the above-described CAM and a solid electrolyte. In addition, the positive electrode active material layer 111 may contain a conductive material and a binder.

### (Negative Electrode)

The negative electrode 120 has a negative electrode active material layer 121 and the negative electrode current collector 122. The negative electrode active material layer 121 contains a negative electrode active material. In addition, the negative electrode active material layer 121 may contain a solid electrolyte and a conductive material. As the negative electrode active material, the negative electrode current collector, the solid electrolyte, the conductive material, and a binder, the same ones as for the lithium secondary battery described above can be used.

For the all-solid-state lithium secondary battery, the configuration, materials, and production method disclosed in to of WO2022/113904A1, for example, can be used.

The present invention also has the following aspects.
[11] A method for producing LiMO, including a calcining step of introducing a gas mixture inside a calcining furnace and calcining a substance to be calcined in the calcining furnace at a temperature of higher than 600° C., in which the substance to be calcined is a raw material mixture containing a mixture of MCC and a lithium compound or a reaction product of MCC and the lithium compound, the gas mixture before introduction contains oxygen, an amount of moisture in the gas mixture is 10 vol % or more and 60 vol % or less, and an amount of carbon oxide in the gas mixture is 2 vol % or less.
[12] The method for producing LiMO according to [11], in which an amount of oxygen in the gas mixture before introduction is more than 11 vol % and 92 vol % or less.
[13] The method for producing LiMO according to [11] or [12], in which the ratio of moisture to powder is 0.1 to 18 m³/kg or less.
[14] The method for producing LiMO according to any one of [11] to [13], in which a calcining time in the calcining step is 3 to 12 hours.
[15] The method for producing LiMO according to any one of [11] to [14], including a cooling step of cooling a calcined product inside the calcining furnace after the calcining step, in which a gas with a dew point of −15° C. or lower is supplied inside the calcining furnace in the cooling step.
[16] The method for producing LiMO according to any one of [11] to [15], in which LiMO satisfies General Formula (I).
[17] The method for producing LiMO according to any one of [11] to [16], in which LiMO satisfies General Formula (I′).

### EXAMPLES

Next, the present invention will be described in further detail by means of Examples.

### <Composition Analysis>

The composition analysis of LiMO was performed by the method described in the above-described section <Composition analysis>.

### <Measurement of Cycle Retention Rate>

The cycle retention rate of the lithium secondary battery using LiMO was measured by the method described in the above-described section <Measurement of cycle retention rate>

### Example 1

After water was poured into a reaction vessel equipped with a stirrer and an overflow pipe, an aqueous solution of sodium hydroxide was added thereto, and the liquid temperature was held at 50° C.

A nickel sulfate aqueous solution, a cobalt sulfate aqueous solution, and a manganese sulfate aqueous solution were mixed together at such a proportion that the atomic ratio of Ni, Co, and Mn satisfied 60:20:20, thereby preparing a raw material liquid mixture.

Next, this raw material liquid mixture and an ammonium sulfate aqueous solution, as a complexing agent, were continuously added into the reaction vessel under stirring. An aqueous solution of sodium hydroxide was timely added dropwise such that the pH of the solution in the reaction vessel reached 11.6 (at the time of measurement at a liquid temperature of 40° C.), and a nickel cobalt manganese composite hydroxide was obtained.

The nickel cobalt manganese composite hydroxide was washed, then dehydrated with a centrifuge, isolated, and dried at 105° C. to obtain a nickel cobalt manganese composite hydroxide 1.

The nickel cobalt manganese composite hydroxide 1 and a lithium hydroxide monohydrate powder were weighed and mixed together at such a proportion that the molar ratio was Li/(Ni+Co+Mn)=1.05, thereby obtaining a substance to be calcined 1.

The substance to be calcined 1 was calcined using the calcining means 30 shown in FIG. 3.

Moisture was supplied to the raw material gas by bubbling using the moisture supply method 36 of Example A described above to adjust the moisture concentration in the gas mixture. Specifically, the dew point at which the moisture concentration in the total volume of the gas mixture was 8 vol % was calculated using the expressions (X) and (Y) described above, and in order to reach this dew point, the water temperature in the water tank was set to 42° C., and the raw material gas was bubbled through the water at a water temperature of 42° C. An oxygen gas was bubbled as the raw material gas. As a result of this, the gas mixture to be introduced into the calcining furnace 37 had a moisture concentration of 8 vol % and an oxygen amount of 92 vol % in the total volume of the gas mixture in the composition before introduction.

At this time, the ratio of moisture to powder was 0.25 m³/kg.

The substance to be calcined 1 was calcined at 955° C. for 5 hours with the calcining furnace 37 to obtain a calcined product. At this time, the temperature rising rate was set at 175° C./hour.

Immediately after the calcining for 5 hours was completed, a gas with a dew point of −15° C. or lower was supplied and the calcined product was cooled to room temperature inside the calcining furnace 37 to obtain LiMO-1. The gas with a dew point of −15° C. or lower, which was supplied at this time, was a gas in which only moisture was substantially removed from the gas mixture described above.

As a result of comparing LiMO-1 with General Formula (I), x was 0.02, y was 0.20, and z was 0.20.

### Example 2

LiMO-2 was obtained by the same method as in Example 1, except that the gas mixture introduced into the calcining furnace 37 was changed to a gas with a moisture concentration of 11 vol %, an oxygen amount of 84 vol %, and a nitrogen amount of 5 vol %, and the ratio of moisture to powder was 0.40 m³/kg. The moisture concentration in the gas mixture was adjusted by setting the water temperature to 47° C. using the moisture supply means 36 of the Example A described above.

As a result of comparing LiMO-2 with General Formula (I), x was 0.02, y was 0.20, and z was 0.20.

### Example 3

LiMO-3 was obtained by the same method as in Example 1, except that the gas mixture introduced into the calcining furnace 37 was changed to a gas with a moisture concentration of 36 vol %, an oxygen amount of 32 vol %, and a nitrogen amount of 32 vol %, the ratio of moisture to powder was 3.9 m³/kg, and the calcining temperature was changed to 925° C. The moisture concentration in the gas mixture was adjusted by setting the water temperature to 74° C. using the moisture supply means 36 of the Example A described above.

As a result of comparing LiMO-3 with General Formula (I), x was 0.00, y was 0.20, and z was 0.20.

### Example 4

After water was poured into a reaction vessel equipped with a stirrer and an overflow pipe, an aqueous solution of sodium hydroxide was added thereto, and the liquid temperature was held at 50° C.

A nickel sulfate aqueous solution, a cobalt sulfate aqueous solution, and a manganese sulfate aqueous solution were mixed together at such a proportion that the atomic ratio of Ni, Co, and Mn was 31.5:33:35.5, thereby preparing a raw material liquid mixture.

Next, this raw material liquid mixture and an ammonium sulfate aqueous solution, as a complexing agent, were continuously added into the reaction vessel under stirring. An aqueous solution of sodium hydroxide was timely added dropwise such that the pH of the solution in the reaction vessel reached 11.6 (at the time of measurement at a liquid temperature of 40° C.), and a nickel cobalt manganese composite hydroxide was obtained.

The nickel cobalt manganese composite hydroxide was washed, then dehydrated with a centrifuge, isolated, and dried at 105° C. to obtain a nickel cobalt manganese composite hydroxide 2.

The nickel cobalt manganese composite hydroxide 2 and a lithium hydroxide monohydrate powder were weighed and mixed together at such a proportion that the molar ratio was Li/(Ni+Co+Mn)=1.10, thereby obtaining a substance to be calcined 2.

The substance to be calcined 2 was calcined using the calcining means 30 shown in FIG. 3.

Moisture was supplied to the raw material gas by bubbling using the moisture supply method 36 of Example A described above to adjust the moisture concentration in the gas mixture. Specifically, the dew point at which the moisture concentration in the total volume of the gas mixture was 41 vol % was calculated using the expressions (X) and (Y) described above, and in order to reach this dew point, the water temperature in the water tank was set to 77° C., and the raw material gas was bubbled through the water at a water temperature of 77° C. A gas containing oxygen and nitrogen was bubbled as the raw material gas. The gas mixture to be introduced into the calcining furnace 37 had a moisture concentration of 41 vol %, an oxygen amount of 18 vol %, and a nitrogen amount of 41 vol % in the composition before introduction.

Also, the ratio of moisture to powder was 8.2 m³/kg.

The substance to be calcined 2 was calcined at 690° C. for 4 hours and further calcined at 935° C. for 4 hours with the calcining furnace 37 to obtain a calcined product. At this time, the temperature rising rate was set at 175° C./hour.

Immediately after the second calcining for 4 hours was completed, a gas with a dew point of −15° C. or lower was supplied and the calcined product was cooled to room temperature inside the calcining furnace 37 to obtain LiMO-4. The gas with a dew point of −15° C. or lower, which was supplied at this time, was a gas in which only moisture was substantially removed from the gas mixture described above. As a result of comparing LiMO-4 with General Formula (I), x was 0.06, y was 0.33, and z was 0.35.

### Example 5

LiMO-5 was obtained by the same method as in Example 3, except that the gas mixture introduced into the calcining furnace 37 was changed to a gas with a moisture concentration of 60 vol %, an oxygen amount of 20 vol %, and a nitrogen amount of 20 vol %, and the ratio of moisture to powder was 8.8 m³/kg. The moisture concentration in the gas mixture was adjusted by setting the water temperature to 86° C. using the moisture supply means 36 of the Example A described above.

As a result of comparing LiMO-5 with General Formula (I), x was −0.01, y was 0.20, and z was 0.20.

### Example 6

LiMO-6 was obtained by the same method as in Example 4, except that the gas mixture introduced into the calcining furnace 37 was changed to a gas with a moisture concentration of 80 vol % and an oxygen amount of 20 vol %, the ratio of moisture to powder was 13 m³/kg, and the substance to be calcined 2 was calcined at 690° C. for 4 hours and further calcined at 905° C. for 4 hours with the calcining furnace 37. The moisture concentration in the gas mixture was adjusted by setting the water temperature to 94° C. using the moisture supply means 36 of the Example A described above.

As a result of comparing LiMO-6 with General Formula (I), x was 0.06, y was 0.33, and z was 0.35.

### Comparative Example 1

LiMO-11 was obtained by the same method as in Example 1, except that the gas mixture introduced into the calcining furnace 37 was changed to a gas with an oxygen amount of 80 vol % and a nitrogen amount of 20 vol % in the composition before introduction. At this time, the ratio of moisture to powder was 0 m³/kg.

As a result of comparing LiMO-11 with General Formula (I), x was 0.02, y was 0.20, and z was 0.20.

### Comparative Example 2

LiMO-12 was obtained by the same method as in Example 1, except that the gas mixture introduced into the calcining furnace 37 was changed to a gas with an oxygen amount of 20 vol % and a nitrogen amount of 80 vol % in the composition before introduction, and the calcining temperature was changed to 925° C. At this time, the ratio of moisture to powder was 0 m³/kg.

As a result of comparing LiMO-12 with General Formula (I), x was 0.03, y was 0.20, and z was 0.20.

### Comparative Example 3

LiMO-13 was obtained by the same method as in Example 1, except that the gas mixture introduced into the calcining furnace 37 was changed to a gas with a moisture concentration of 6 vol % and an oxygen amount of 94 vol % in the composition before introduction, and the ratio of moisture to powder was 0.20 m³/kg. The moisture concentration in the gas mixture was adjusted by setting the water temperature to 36° C. using the moisture supply means 36 of the Example A described above.

As a result of comparing LiMO-13 with General Formula (I), x was 0.01, y was 0.20, and z was 0.20.

### Comparative Example 4

LiMO-14 was obtained by the same method as in Example 1, except that the gas mixture introduced into the calcining furnace 37 was changed to a gas with a moisture concentration of 11 vol %, an oxygen amount of 3 vol %, a nitrogen amount of 77 vol %, and a carbon dioxide amount of 9 vol % in the composition before introduction, and the ratio of moisture to powder was 10 m³/kg. The moisture concentration in the gas mixture was adjusted by setting the water temperature to 48° C. using the moisture supply means 36 of the Example A described above.

As a result of comparing LiMO-14 with General Formula (I), x was −0.03, y was 0.20, and z was 0.20.

Table 1 shows the results of cycle retention rate of lithium secondary batteries in a case where LiMO-1 to LiMO-6 and LiMO-11 to LiMO-14 obtained in Examples 1 to 6 and Comparative Examples 1 to 4 were used.

TABLE 1

| | | Comparative | Comparative | Comparative | Comparative | | |
|---|---|---|---|---|---|---|---|
| | Unit | Example 1 | Example 2 | Example 3 | Example 4 | Example 1 | Example 2 |
| Moisture | Vol % | 0 | 0 | 6 | 11 | 8 | 11 |
| concentration | | | | | | | |
| O₂ | Vol % | 80 | 20 | 94 | 3 | 92 | 84 |
| concentration | | | | | | | |
| N₂ | Vol % | 20 | 80 | 0 | 77 | 0 | 5 |
| concentration | | | | | | | |
| CO₂ | Vol % | 0 | 0 | 0 | 9 | 0 | 0 |
| concentration | | | | | | | |
| Ratio of | m³/kg | 0 | 0 | 0.20 | 10 | 0.25 | 0.40 |
| moisture to | | | | | | | |
| powder | | | | | | | |
| Highest | ° C. | 955 | 925 | 955 | 955 | 955 | 955 |
| calcining | | | | | | | |
| temperature | | | | | | | |
| Calcining | Hours | 5 | 5 | 5 | 5 | 5 | 5 |
| time | | | | | | | |
| Composition | — | 60/20/20 | 60/20/20 | 60/20/20 | 60/20/20 | 60/20/20 | 60/20/20 |
| (Ni/Co/Mn) | | | | | | | |
| Dry gas | Supplied/ | Supplied | Supplied | Supplied | Supplied | Supplied | Supplied |
| supply in | Not supplied | | | | | | |
| cooling step | | | | | | | |
| Cycle | % | 88.1 | 87.7 | 88.1 | 86.9 | 90.3 | 91.4 |
| retention rate | | | | | | | |

| | Unit | Example 3 | Example 4 | Example 5 | Example 6 |
|---|---|---|---|---|---|
| Moisture | Vol % | 36 | 41 | 60 | 80 |
| concentration | | | | | |
| O₂ | Vol % | 32 | 18 | 20 | 20 |
| concentration | | | | | |
| N₂ | Vol % | 32 | 41 | 20 | 0 |
| concentration | | | | | |
| CO₂ | Vol % | 0 | 0 | 0 | 0 |
| concentration | | | | | |
| Ratio of | m³/kg | 3.9 | 8.2 | 8.8 | 13 |
| moisture to | | | | | |
| powder | | | | | |
| Highest | ° C. | 925 | First calcining: 690° C. | 925 | First calcining: 690° C. |
| calcining | | | Second calcining: 935° C. | | Second calcining: 905° C. |
| temperature | | | | | |
| Calcining | Hours | 5 | First calcining: 4 hours | 5 | First calcining: 4 hours |
| time | | | Second calcining: 4 hours | | Second calcining: 4 hours |
| Composition | — | 60/20/20 | 31.5/33/35.5 | 60/20/20 | 31.5/33/35.5 |
| (Ni/Co/Mn) | | | | | |
| Dry gas | Supplied/ | Supplied | Supplied | Supplied | Supplied |
| supply in | Not supplied | | | | |
| cooling step | | | | | |
| Cycle | % | 92.0 | 94.4 | 90.9 | 92.7 |
| retention rate | | | | | |

As shown in Table 1, it was confirmed that all lithium secondary batteries using LiMO of Examples, which were calcined with introduction of specific gas mixtures into the calcining furnace and obtained by the production method of the present embodiment, had a cycle retention rate of 90% or more.

As for Comparative Examples 1 to 3, it is considered that, since the moisture concentration in the gas mixture was low, LiMO had low crystallinity, resulting in a decreased cycle retention rate.

As for Comparative Example 4, it is considered that, since the carbon dioxide concentration in the gas mixture was high, the amount of lithium carbonate remaining was high, and carbon dioxide gas was generated when the lithium secondary battery was operated, resulting in a decreased cycle retention rate.

### REFERENCE SIGNS LIST

1: Separator, 3: Negative electrode, 4: Electrode group, 5: Battery can, 6: Electrolytic solution, 7: Top insulator, 8: Sealing body, 10: Lithium secondary battery, 21: Positive lead, 31: Negative lead, 100: Laminate, 110: Positive electrode, 111: Positive electrode active material layer, 112: Positive electrode current collector, 113: External terminal, 120: Negative electrode, 121: Negative electrode active material layer, 122: Negative electrode current collector, 123: External terminal, 130: Solid electrolyte layer, 200: Exterior body, 200a: Opening portion, 1000: All-solid-state lithium secondary battery, 30: Calcining means, 32: Gas supply device, 33: Oxygen gas supply means, 34: Inert gas supply means, 35: Carbon dioxide gas supply means, 36: Moisture supply means, 37: Calcining furnace, 38a to 38c: Flow meter, 39a to 39f: Valve, 40a to 40c: Supply channel, 42: Supply channel

1. A method for producing a lithium metal composite oxide, comprising a calcining step of introducing a gas mixture inside a calcining furnace and calcining a substance to be calcined in the calcining furnace at a temperature of higher than 600° C.,
wherein the substance to be calcined is a raw material mixture containing a mixture of a metal composite compound and a lithium compound or a reaction product of the metal composite compound and the lithium compound,
the gas mixture before introduction contains oxygen,
an amount of moisture in the gas mixture is 8 vol % or more and 85 vol % or less, and
an amount of carbon dioxide in the gas mixture is less than 4 vol %.

2. The method for producing the lithium metal composite oxide according to claim 1,
wherein an amount of oxygen in the gas mixture before introduction is 10 vol % or more and 92 vol % or less.

3. The method for producing the lithium metal composite oxide according to claim 1,
wherein a total amount of moisture (m³) introduced into the calcining furnace with respect to a charged powder mass (kg) of the substance to be calcined is 0.1 m³/kg or more and 20 m³/kg or less.

4. The method for producing the lithium metal composite oxide according to claim 1,
wherein a calcining time in the calcining step is 1 hour or longer and 24 hours or shorter.

5. The method for producing the lithium metal composite oxide according to claim 1, comprising a cooling step of cooling a calcined product inside the calcining furnace after the calcining step,
wherein a gas with a dew point of −15° C. or lower is supplied inside the calcining furnace in the cooling step.

6. The method for producing the lithium metal composite oxide according to claim 1,
wherein the lithium metal composite oxide satisfies General Formula (I) below,
Li[Liₓ(Ni_{(1-y-z)}Co_{y}X_{z})₁₋ₓ]O₂ (I)
(in Formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y≤0.4, and 0≤z≤0.5 are satisfied.)

7. The method for producing the lithium metal composite oxide according to claim 2,
wherein a total amount of moisture (m³) introduced into the calcining furnace with respect to a charged powder mass (kg) of the substance to be calcined is 0.1 m³/kg or more and 20 m³/kg or less.

8. The method for producing the lithium metal composite oxide according to claim 2,
wherein a calcining time in the calcining step is 1 hour or longer and 24 hours or shorter.

9. The method for producing the lithium metal composite oxide according to claim 2, comprising a cooling step of cooling a calcined product inside the calcining furnace after the calcining step,
wherein a gas with a dew point of −15° C. or lower is supplied inside the calcining furnace in the cooling step.

10. The method for producing the lithium metal composite oxide according to claim 2,
wherein the lithium metal composite oxide satisfies General Formula (I) below,
Li[Liₓ(Ni_{(1-y-z)}Co_{y}X_{z})₁₋ₓ]O₂ (I)
(in Formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y≤0.4, and 0≤z≤0.5 are satisfied.)
